(19) United States
(12) Patent Application Publication
(10) Pub. No.: US 2012/0249770 A1
(43) Pub. Date: Oct. 4, 2012

(54) METHOD FOR AUTOMATICALLY FOCUSING A MICROSCOPE ON A PREDETERMINED OBJECT AND MICROSCOPE FOR AUTOMATIC FOCUSING

(75) Inventors: Peter Hamm, Goettingen (DE); Karl-Hans Englmeier, Muenchen (DE); Thomas Waschulzik, Freising (DE); Horst Wolff, Siegenburg (DE)

(73) Assignee: CARL ZEISS MICROIMAGING GMBH, Jena (DE)

(21) Appl. No.: 13/395,441

(22) PCT Filed: Aug. 20, 2010
(86) PCT No.: PCT/EP2010/062185

§ 371 Date: May 19, 2012

(30) Foreign Application Priority Data
Sep. 11, 2009 (DE) 102009041183.6

(51) Int. Cl. H04N 7/18

(52) U.S. Cl. 348/79; 348/E07.085

(57) ABSTRACT

A method for automatic focusing of a microscope on a predetermined object in a specimen to be examined may include
a) producing a set of criteria to be satisfied for the predetermined object using at least one training image of the object,
b) producing a first image of the specimen to be examined which contains the predetermined object with the microscope in a first focal position,
c) ascertaining the section or sections of the first image, which in each case satisfies or satisfy the set of criteria according to step a), and defining each ascertained section as object area of the first image,
d) producing further images of the specimen with the microscope in different focal positions,
e) determining the optimum focal position(s) using the further images, wherein, for this purpose, in all images only the partial region or partial regions which correspond to the object area or object areas is/are evaluated,
f) focusing the microscope on at least one of the optimum focal position(s) determined in step e).

The present invention relates to a method for automatic focussing of a microscope on a predetermined object as well as a microscope for automatic focussing.

Known automatic focussing methods evaluate the whole specimen which contains the object to be examined in order to carry out an automatic focussing. This is time-consuming on the one hand and also error-prone on the other hand, in particular in cases where, in addition to the predetermined object, the specimen to be recorded with the microscope contains further objects, which are e.g. very similar to the predetermined object, which are not to be focussed on.

On this basis, it is therefore the object of the invention to provide a method for automatic focussing of a microscope on a predetermined object in a specimen to be examined with the microscope, with which a good automatic focussing is achieved. Further, a corresponding microscope is to be made available.

The object is achieved by a method for automatic focussing of a microscope on a predetermined object in a specimen to be examined with the microscope, with the steps

a) producing a set of criteria to be satisfied for the predetermined object using at least one training image of the object,

b) producing a first image of the specimen to be examined which contains the predetermined object with the microscope in a first focal position,

c) ascertaining the section or sections of the first image, which in each case satisfies or satisfy the set of criteria according to step a), and defining each ascertained section as object area of the first image,

d) producing further images of the specimen with the microscope in different focal positions,

e) determining the optimum focal position(s) using the further images, wherein, for this purpose, in all images only the partial region or partial regions which correspond to the object area or object areas is/are evaluated,

f) focussing the microscope on at least one of the optimum focal position(s) determined in step e).

Because, according to the invention, only the partial region or partial regions which correspond to the object area or object areas are to be evaluated in the further images, an excellent focussing can be achieved. In particular, a disadvantageous or interfering influence of undesired objects that are similar to the predetermined object can be reliably avoided, as these undesired objects are not taken into account when determining the optimum focal position(s).

Thus, with the method according to the invention a pattern recognition is carried out in step c) in order to ascertain the predetermined object or the corresponding region in which the predetermined object lies.

This pattern recognition can be carried out in particular such that the first image is analyzed in sections in order to ascertain whether the respective section satisfies the set of criteria according to step a).

By section of an image is meant here in particular a partial region or a picture section of the image. Thus the region of interest of the image is involved.

By the predetermined object is meant here in particular an object of interest to the user. However, the predetermined object can also denote one or more different object classes which contain identical or similar objects.

The first image of the specimen to be examined according to step b) can contain a channel (for example a bright-field image) or also several channels. By image with several channels is meant here in particular that different image conditions, image methods, etc are allocated to the different channels. The several channels can be e.g. fluorescence channels which can be excited and recorded simultaneously or successively. Thus e.g. the specimen can contain several fluorophores which are to be excited to fluorescence with different excitation wavelengths. When the channels are recorded successively, only the wavelength of the illumination radiation need be changed, with the result that the first image with all fluorescence channels can be produced relatively quickly. Thus it is possible to switch between different excitation wavelengths in milliseconds, with the result that e.g. 20 milliseconds are required to produce the first image with three fluorescence channels. This is relatively fast, as in a conventional microscope the Z control requires approximately 10-20 milliseconds to set a new focal position. In addition, often after setting a new focal position it is necessary to wait a predetermined period of time before producing the image in order for undesired vibrations due to the movement by the Z control to have subsided sufficiently.

In the case of an image with several channels, as a rule the criteria to be satisfied are different for each channel. This is naturally taken into account in steps a) and c).

In step f), it is possible to focus on exactly one specific optimum focal position. This can be e.g. a focal position selected by the user. However it is also possible that in step e) the focal positions are also weighted or classified among one another and in step f) the focus is on the best ascertained optimum focal position.

Naturally it is also possible to successively focus several or all of the optimum focal positions determined in step e).

Furthermore, it is possible to focus in step f) such that at least two of the optimum focal positions determined in step e) are focussed on simultaneously. This is readily possible for example when the distance between the at least two optimum focal positions is no greater than the depth of field of the microscope. Alternatively, it is possible, after producing further images according to step d), to appropriately increase the depth of field of the microscope by means of e.g. a pivotable element. Although this can lead to a lower spatial resolution, the at least two optimum focal positions can be focussed simultaneously and thus recorded and evaluated. In particular, it is possible to use the information about the optimum focal positions in order to set the depth of field of the microscope such that the predetermined objects can be imaged sharply from at least two optimum focal positions simultaneously.

In the case of the method according to the invention, in step a) unsharp images of the objects and/or different rotation positions of the object can be calculated and taken into account when producing the set of criteria to be satisfied.

Likewise in step a) undesired objects which are not to be imaged sharply or confused with the predetermined object can be taken into account when producing the set of criteria. In particular, unsharp images and/or different rotation positions, which are taken into account when producing the set of criteria, can also be calculated for the undesired objects.

In the method according to the invention, the training image can be produced with the microscope. This is advantageous in particular in that the boundary conditions for producing the training image and for producing the images are thus comparable.

In step e), the first image can of course also be taken into account to determine the optimum focal position(s).

In the method according to the invention, the user can mark a region in an image of the microscope and/or in the training image as predetermined object or as undesired object which is not to be focussed on, and this marked region is taken into account when producing the set of criteria.

In the method according to the invention, the set of criteria to be satisfied can be ascertained by methods of pattern recognition and classification. By these are meant here in particular model-based methods using object contours, size, etc., feature-based methods (e.g. using textural partial features, edges, etc.) as well as appearance-based methods which e.g. evaluate global features that are usually obtained by transformation, such as e.g. by means of a principle component analysis or a wavelet transformation (by means of wavelet filters).

The set of criteria to be satisfied can be in particular wavelet filters (e.g. Haar filters) with allocated threshold values. Other pattern recognition algorithms or filters can also be used for the set of criteria to be satisfied.

For step e), a calculation of a sharpness function in the partial region or partial regions can be carried out to determine the optimum focal position(s). By calculation of the sharpness function is meant here in particular statistical methods (e.g. pixel intensity average, absolute intensity, autocorrelation, variance analysis), gradient-based methods as well as histogram-based methods, which can optionally also be combined with one another.

Further, the object is achieved by a microscope for automatic focussing on a predetermined object in a specimen to be examined, wherein the microscope has imaging optics for magnified imaging of the specimen, a recording unit for recording the magnified image and a control unit which carries out the following steps for automatic focussing:

b) producing a first image of the specimen to be examined which contains the predetermined object in a first focal position,

c) ascertaining the section or sections of the first image, which in each case satisfies or satisfy a set of criteria supplied to the microscope for the predetermined object, and defining each ascertained section as object area of the first image,

C) producing further images of the specimen in different focal positions,

D) determining the optimum focal position(s) using the further images, wherein, for this purpose, in all images only the partial region or partial regions which correspond to the object area or object areas is/are evaluated,

E) focussing the microscope on at least one of the optimum focal position(s) determined in step e).

An excellent automatic focussing is possible with the microscope according to the invention. In particular incorrect focussing can be avoided.

The recording unit can comprise a camera, e.g. a CCD camera. However, it is also possible for the recording unit to be formed as a point scanner (point imaging) or line scanner. In this case, the microscope is preferably a laser scanning microscope.

The microscope can further be formed as a fluorescence microscope, as a multichannel fluorescence microscope, as a phase-contrast microscope or other microscope.

Developments of the microscope according to the invention are given in the dependent device claims.

In particular, the microscope is constructed such that the method according to the invention as well as the developments of the method according to the invention can be carried out with it.

The computing module according to the developments of the microscope according to the invention can be realized by the control unit of the microscope itself or formed as a separate computing module.

It is understood that the features mentioned above and those yet to be explained below can be used, not only in the stated combinations, but also in other combinations or alone, without departing from the scope of the present invention.

The invention is explained in further detail below by way of example using the attached drawings which also disclose features essential to the invention. There are shown in:

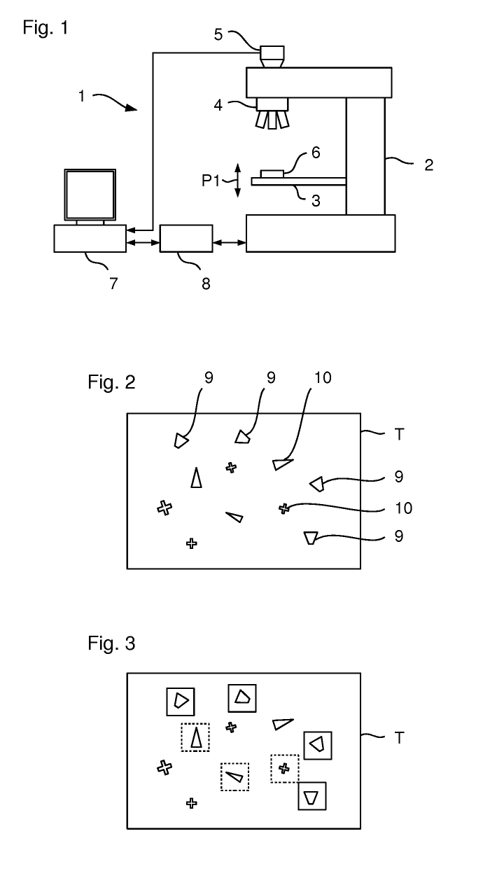

FIG. 1 a schematic view of the microscope according to the invention;

FIG. 2 a schematic view of a training image T;

FIG. 3 a schematic view of the training image T of FIG. 2 with marked desired and undesired objects;

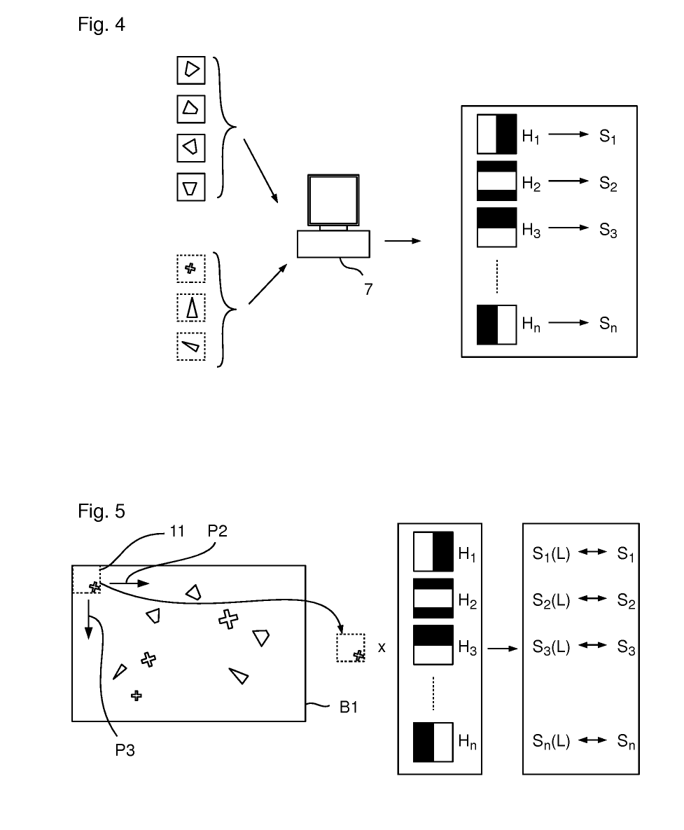

FIG. 4 a schematic view illustrating how the set of criteria is produced;

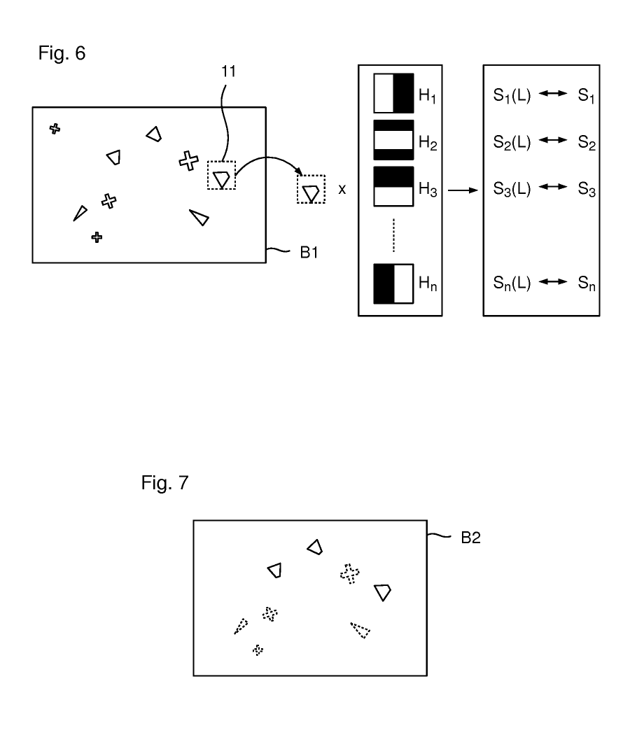

FIGS. 5 and 6 schematic views illustrating how the object areas in which the sought object lies are ascertained, and

FIG. 7 a schematic view of the automatically focussed specimen image.

In the embodiment shown in FIG. 1, the microscope 1 according to the invention comprises a stand 2 with a specimen stage 3 as well as a microscope lens system 4 for which an objective nosepiece with three objectives is drawn in schematically. The distance between microscope lens system 4 (objective nosepiece) and specimen stage 3 can be changed for focussing, as indicated by the double arrow P1 in FIG. 1.

The microscope 1 further comprises a camera 5 (for example a CCD camera) with which the magnified picture of a specimen 6 to be examined can be recorded. The camera 5 is connected to a schematically represented computer 7 which controls the operation of the microscope 1 via a control module 8.

With the microscope 1 according to the invention, an automatic focussing on a predetermined or sought object 9 in the specimen 6 is possible, wherein in an initial preprocessing the microscope 1 or computer 7 is firstly to be trained on the predetermined object.

For this, e.g. the microscope 1 can be used to record a training image T of a specimen which is comparable to the specimen 6 which is then to be examined.

Such a training image T is shown schematically in FIG. 2, wherein the predetermined object 9 is represented as a trapezium in the example described here. Thus there are four sought objects 9 in the training image T according to FIG. 2. The triangles and crosses drawn in are to represent undesired objects 10 which can be present in the specimen 6 and are not to be confused with the sought objects 9.

The user can mark the sought objects 9 in the training image T (indicated by the squares with solid lines in FIG. 3), the user can further mark the undesired objects 10, as is indicated by the squares with dotted lines. If the user does not mark any undesired objects 10, e.g. the computer 7 can itself select regions of the training image T, in which no sought objects 9 are marked, as undesired objects 10.

The computer then produces from these marked sections transformed instances which are characterized on the one hand by rotation about the centre of the section and on the other hand by convolution with low-pass functions of varying smoothing parameters. With the convolution, unsharp images of the sought object 9 as well as of the undesired objects 10 are quasi-simulated, with the result that with the automatic focussing according to the invention the sought objects 9 are automatically recognized even when they do not lie in the focal plane during the recording by means of the microscope.

From these marked sections and instances, the computer 7 ascertains in a training algorithm based on Haar wavelets, by boosting in an iterative process, the Haar filters H with associated threshold value S with which the best separation between the desired and undesired objects 9, 10 can be achieved. The Haar filters H with associated threshold values can also be characterized as a set of criteria to be satisfied for the sought object 9.

The Haar filters H₁, H₂, H₃, . . . Hₙ are shown schematically in FIG. 4, wherein for example the Haar filter H₁ responds to a vertical edge with a bright-dark transition, the Haar filter H₂ to a horizontal edge with a dark-bright-dark transition, the Haar filter H₃ to a horizontal edge with a bright-dark transition and the Haar filter Hₙ to a vertical edge with a dark-bright transition.

Naturally, the training algorithm can be carried out with a large number of training images in order to achieve a very high recognition rate of the sought object 9 during the automatic focussing then carried out.

During automatic focussing, when the initial preprocessing is concluded, a first image B1 of the specimen 6 in a random focal position is produced by means of the microscope 1 and then, as is shown in FIGS. 5 and 6, analyzed in sections. For this, the schematically shown sliding window 11 can be moved over the whole first image B1, as is indicated by the arrows P2 and P3, and for every displacement position L the filter responses S₁(L), S₂(L), S₃(L), . . . , Sₙ(L) of the selected Haar filters H₁, H₂, H₃, Hₙ are calculated with the picture section at the displacement position L and compared with the threshold values S₁, S₂, S₃, . . . , Sₙ. When all filter responses S₁(L), S₂(L), S₃(L), . . . , Sₙ(L) or a predetermined number of the filter responses are greater than the associated threshold values S₁, S₂, S₃, . . . Sₙ, the corresponding picture section or region is specified as the object area in which the object to be examined lies. In the case of the shown displacement positions L of the sliding window L in FIGS. 5 and 6, this applies only to the displacement position L of FIG. 6.

The step size during movement of the sliding window 11 can be constant or variable. The size of the sliding window 11 is preferably set such that the predetermined object fits as fully as possible into the sliding window, taking into account the set magnification of the microscope.

Several images of the whole specimen 6 in different focal positions or locations (different distance between specimen 6 and microscope lens system 4) are then recorded and in all images only the partial region or the partial regions which correspond to the object area(s) are evaluated in order to ascertain the best focal position. For example, a variance analysis of the intensity can be carried out. For example, by estimating the maximum and variable step size in z direction (direction of the double arrow P1), the necessity of carrying out the focus measurement over the whole z region of the specimen 6 can be avoided.

After ascertaining the focal plane, the microscope 1 is automatically focussed on this focal plane, as is indicated in FIG. 7, wherein in this representation of the image B2 the sharply imaged objects are drawn in with solid lines and the unsharply imaged objects with dotted lines.

If there are several sought objects in different planes in the specimen 6, several focal planes are ascertained according to the invention. Once these have been ascertained, the microscope 1 is focussed on one of the ascertained focal planes. This can be e.g. the focal plane selected by the user or the focal plane which is classified as the best focal plane by the method according to the invention. The criteria for such a classification can be e.g. specified by the user.

Further, it is possible that the microscope is focussed successively on several or all ascertained focal planes.

If a next specimen is then to be examined which contains the same sought objects 9, the initial preprocessing described above with the training algorithm is no longer necessary. The desired automatic focussing can take place immediately.

Thus, with the method according to the invention, a content-based automatic focussing search is realized in which only the sought objects in the specimen 6 to be examined are included in the focus measurement. Thus the whole picture content is no longer taken into account in the focus measurement, with the result that undesired objects that can make the automatic focussing difficult or even impossible are no longer taken into account. On the basis of the initial preprocessing, the user or operator can thus select the desired object which is then automatically brought into the focus.

After the initial preprocessing, ascertaining the optimum focal plane within the microscopic specimen 6 is thus a two-stage process. The starting point of the focus search is the two-dimensional first image of a random plane within the specimen 6 to be examined in which the object areas (areas of interest) are sought. The extent of the sliding window 11 is chosen according to the magnification of the microscope lens system 4 as well as the dimensions of the sought object 9. When the object areas have been thus determined, the first stage of the two-stage process is concluded.

In the second stage of the two-stage process, the z plane(s) in which the sought object or objects lie are determined, using only the data from these object areas or the corresponding partial regions of the further images, in order to be able to image them sharply.

For example, the result of the picture variance analysis of the respective partial regions can serve as focus measurement value. This focus measurement value is calculated in several z planes (of the different images) at the same xy position (same partial regions) and an estimation of the measurement value curve (focus curve) over the whole z region is carried out e.g. based on these focus measurement values. With the customary assumption that the maximum of the focus curve points to the focal plane, the computer activates the motor of the microscope 1 via the control module 8 to adjust the distance between specimen stage 3 and microscope lens system 4 to the distance corresponding to the curve maximum (or the corresponding z coordinates).

Through this process, it is advantageously achieved that a reliable automatic focussing is ensured as only the desired objects 9 within the specimen 6 are subjected to the focus analysis. Other objects 10 which sometimes slightly negatively influence the focus search are not taken into account in the determination according to the invention of the focal plane.

In one development, it is possible for the user to mark incorrectly focussed objects in the automatically focussed picture. In this case, the training algorithm is carried out once more with this additional information, preferably as a background process of which the user is not made aware, in order to achieve an improved recognition of the sought objects 9 in the next automatic focussing.

In a further variant, a further pattern recognition based on a different set of features can be carried out after the automatic focussing. With this set of features, it is possible for example not to take account of a defocus portion (as e.g. no convolution with low-pass functions), but only rotations.

With the described microscope according to the invention, a two-class problem is taken as a basis for object recognition, namely the sought objects 9 (=positives) as well as the not sought objects 10 (=negatives). However, an expansion to include several classes is easily possible, e.g. object class A, object class B and negatives.

Further, it is possible to store different sets of criteria to be satisfied for different sought objects and to select the appropriate set depending on the specimen 6 to be examined, with the result that the desired automatic focussing is carried out. In particular, the automatic focussing can be activated by the user.

The microscope according to the invention can be formed in particular as a bright-field microscope, a fluorescence microscope, a laser scanning microscope or any other microscope. The specimen to be examined can be in particular medical and/or biological specimens, wherein the sought object is e.g. a specific cell or a living microorganism.

1-27. (canceled)

28. A method for automatic focusing of a microscope on a predetermined object in a specimen to be examined with the microscope, the method comprising:
a) producing a set of criteria to be satisfied for the predetermined object using at least one training image of the object;
b) producing a first image of the specimen to be examined which contains the predetermined object with the microscope in a first focal position;
c) ascertaining the section or sections of the first image, which in each case satisfies or satisfy the set of criteria according to step a), and defining each ascertained section as object area of the first image;
d) producing further images of the specimen with the microscope in different focal positions;
e) determining the optimum focal position(s) using the further images, wherein, for this purpose, in all images only the partial region or partial regions which correspond to the object area or object areas is/are evaluated; and
f) focusing the microscope on at least one of the optimum focal position(s) determined in step e).

29. The method according to claim 28, wherein in step c), in order to ascertain the section or sections, the first image is analyzed in sections in order to ascertain whether the respective section satisfies the set of criteria according to step a).

30. The method according to claim 28, wherein in step a) unsharp images of the object are calculated and taken into account when producing the set of criteria to be satisfied.

31. The method according to claim 28, wherein in step a) different rotation positions of the object are calculated and taken into account when producing the set of criteria to be satisfied.

32. The method according to claim 28, wherein the training image is produced by the microscope.

33. The method according to claim 28, wherein a user can mark a region in at least one of an image of the microscope and in the training image as predetermined object or as undesired object which is not to be focused on, and this marked region is taken into account when producing the set of criteria to be satisfied.

34. The method according to claim 28, wherein the criteria to be satisfied are ascertained by methods of pattern recognition and classification.

35. The method according to claim 28, wherein the criteria to be satisfied are wavelet filters with allocated threshold values.

36. The method according to claim 28, wherein in step e) the determination of the optimum focal position(s) is carried out by calculating a sharpness function in the partial region or partial regions.

37. The method according to claim 28, wherein the first image has several channels and in step c) the criteria of the set of criteria of step a) allocated to the respective channel are taken into account for each channel.

38. The method according to claim 28, wherein in step e) there is selected from the ascertained optimum focal positions a best focal position which is focused on in step f).

39. The method according to claim 28, wherein in step f) the ascertained optimum focal positions are focused on successively.

40. The method according to claim 28, wherein in step f) at least two of the ascertained optimum focal positions are focused on simultaneously.

41. A microscope for automatic focusing on a predetermined object in a specimen to be examined, the microscope comprising:
imaging optics for magnified imaging of the specimen,
a recording unit for recording the magnified image; and
a control unit configured to carry out the following steps for automatic focusing:
A) producing a first image of the specimen to be examined which contains the predetermined object in a first focal position;
B) ascertaining the section or sections of the first image, which in each case satisfies or satisfy a set of criteria supplied to the microscope for the predetermined object, and defining each ascertained section as object area of the first image;
C) producing further images of the specimen in different focal positions;
D) determining the optimum focal position(s) using the further images, wherein, for this purpose, in all images only the partial region or partial regions which correspond to the object area or object areas is/are evaluated; and
E) focusing the microscope on at least one of the optimum focal position(s) determined in step e).

42. The microscope according to claim 41, wherein in step B), in order to ascertain the section or sections, the control unit analyzes the first image in sections in order to ascertain whether the respective section satisfies the supplied set of criteria.

43. The microscope according to claim 41, further comprising a computing module configured to determine the set of criteria to be satisfied for the predetermined object using at least one training image of the object.

44. The microscope according to claim 43, wherein the computing module calculates and takes into account unsharp images of the object when producing the set of criteria to be satisfied.

45. The microscope according to claim 43, wherein the computing module calculates and takes into account different rotation positions of the object when producing the set of criteria to be satisfied.

46. The microscope according to claim 43, wherein the training image is produced by the microscope.

47. The microscope according to claim 43, wherein a user can mark a region in at least one of an image of the microscope and in the training image as predetermined object or as undesired object which is not to be focused on, and the computing module takes this marked region into account when producing the set of criteria to be satisfied.

48. The microscope according to claim 41, wherein the criteria to be satisfied are ascertained by methods of pattern recognition and classification.

49. The microscope according to claim 41, wherein the criteria to be satisfied are wavelet filters with allocated threshold values.

50. The microscope according to claim 41, wherein in step D) the determination of the optimum focal position(s) is carried out by calculating a sharpness function in the partial region or partial regions.

51. The microscope according to claim 41, wherein the first image according to step A) has several channels and in step B) the criteria of the supplied set of criteria allocated to the respective channel are taken into account for each channel.

52. The microscope according to claim 41, wherein in step D) there is selected from the ascertained optimum focal positions a best focal position which is focused on in step E).

53. The microscope according to claim 41, wherein in step E) the ascertained optimum focal positions are focused on successively.

54. The microscope according to claim 41, wherein in step E) at least two of the ascertained optimum focal positions are focused on simultaneously.
